(19) United States
(12) Patent Application Publication
(10) Pub. No.: US 2023/0145512 A1
(43) Pub. Date: May 11, 2023

(54) METHOD AND APPARATUS FOR CONFIGURING SESSION CONNECTION MODE USING NETWORK DATA ANALYTICS FUNCTION IN WIRELESS COMMUNICATIONS SYSTEM

(71) Applicant: Samsung Electronics Co., Ltd., Gyeonggi-do (KR)

(72) Inventor: Jungshin PARK, Gyeonggi-do (KR)

(21) Appl. No.: 17/984,654

(22) Filed: Nov. 10, 2022

(30) Foreign Application Priority Data
Nov. 11, 2021 (KR) 10-2021-0155107

(51) Int. Cl. H04L 67/142

(52) U.S. Cl. CPC H04L 67/142

(57) ABSTRACT

The disclosure relates to a 5G or 6G communication system for supporting a higher data transmission rate. A method performed by a network data analytics function (NWDAF) in a mobile communication system is provided. The method includes receiving, from a session management function (SMF), a message requesting a subscription to a data analysis service related to a service and session continuity mode selection policy (SSCMSP); obtaining network data provided by a network data provision service of the SMF and user equipment (UE) data collected by a UE for the data analysis service; generating analytics for the SSCMSP based on the network data and the UE data; and transmitting, to the SMF, the analytics for the SSCMSP.

### CROSS-REFERENCE TO RELATED APPLICATIONS

This application is based on and claims priority under 35 U.S.C. § 119 to Korean Patent Application No. 10-2021-0155107, which was filed in the Korean Intellectual Property Office on Nov. 11, 2021, the entire disclosure of which is incorporated herein by reference.

### BACKGROUND

### 1. Field

The disclosure relates generally to a wireless communication system and, more particularly, to a method and apparatus for configuring a session mode of a terminal in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broad bands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning. Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In order for a terminal and a server of the network to communicate smoothly using a wireless communication system, it is important to configure a session connection mode according to characteristics of an application to be used and a situation of the network and communication resources of the wireless communication system. If information about the characteristics of the application using the session for wireless communication and information about the change of resources allocated to the session are not provided, the performance of the application may be significantly reduced or the application may not operate properly.

### SUMMARY

The disclosure has been made to address the above-mentioned problems and disadvantages, and to provide at least the advantages described below.

An aspect of the disclosure is to prove a system and method thereof, wherein state information of a session associated with each application is provided to a terminal and an application server, in order to improve the efficiency of network resources and the quality of service experienced by the terminal.

In accordance with an aspect of the disclosure, a method performed by a network data analytics function (NWDAF) in a mobile communication system is provided. The method includes receiving, from a session management function (SMF), a message requesting a subscription to a data analysis service related to a service and session continuity mode selection policy (SSCMSP); obtaining network data provided by a network data provision service of the SMF and UE data collected by a UE for the data analysis service; generating analytics for the SSCMSP based on the network data and the UE data; and transmitting, to the SMF, the analytics for the SSCMSP.

In accordance with another aspect of the disclosure, a method performed by an SMF in a mobile communication system is provided. The method includes transmitting, to an NWDAF, a message requesting a subscription to a data analysis service related to an SSCMSP; transmitting, to the NWDAF, network data provided by a network data provision service of the SMF; and receiving, from the NWDAF, analytics for the SSCMSP. The analytics for the SSCMSP are based on the network data and UE data collected by a UE for the data analysis service.

In accordance with another aspect of the disclosure, a method performed by a UE in a mobile communication system is provided. The method includes receiving a message for a UE data collection setup triggered by an NWDAF; collecting UE data for a data analysis service related to an SSCMSP based on the message for the UE data collection setup; and transmitting the collected UE data for the data analysis service.

In accordance with another aspect of the disclosure, an NWDAF in a mobile communication system is provided. The NWDAF includes a transceiver and a controller. The controller is configured to receive, from an SMF, via the transceiver, a message requesting a subscription to a data analysis service related to an SSCMSP, obtain network data provided by a network data provision service of the SMF and UE data collected by a UE for the data analysis service, generate analytics for the SSCMSP based on the network data and the UE data, and transmit, to the SMF, via the transceiver, the analytics for the SSCMSP.

In accordance with another aspect of the disclosure, an SMF in a mobile communication system is provided. The SMF includes a transceiver and a controller. The controller is configured to transmit, to an NWDAF, via the transceiver, a message requesting a subscription to a data analysis service related to an SSCMSP, transmit, to the NWDAF, via the transceiver, network data provided by a network data provision service of the SMF, and receive, from the NWDAF, via the transceiver, analytics for the SSCMSP. The analytics for the SSCMSP are based on the network data and UE data collected by a UE for the data analysis service.

In accordance with another aspect of the disclosure, a UE in a mobile communication system is provided. The UE includes a transceiver and a controller. The controller is configured to receive, via the transceiver, a message for a UE data collection setup triggered by an NWDAF, collect UE data for a data analysis service related to an SSCMSP based on the message for the UE data collection setup, and transmit, via the transceiver, the collected UE data for the data analysis service.

### BRIEF DESCRIPTION OF TIIE DRAWINGS

The above and other aspects, features, and advantages of certain embodiments of the disclosure will be more apparent from the following description taken in conjunction with the accompanying drawings, in which:

FIG. 1 illustrates a 5G system (5GS) according to an embodiment;

FIG. 2 illustrates a procedure for updating a session mode selection policy of a UE according to an embodiment;

FIG. 3 illustrates a procedure for updating a session mode selection policy according to an embodiment;

FIG. 4 is a flowchart illustrating operations of an NWDAF according to an embodiment;

FIG. 5 is a flowchart illustrating operations of an SMF according to an embodiment;

FIG. 6 illustrates an NF of a 5GS according to an embodiment; and

FIG. 7 illustrates a UE according to an embodiment.

### DETAILED DESCRIPTION

Various embodiments of the disclosure are described with reference to the accompanying drawings. However, various embodiments of the present disclosure are not limited to particular embodiments, and it should be understood that modifications, equivalents, and/or alternatives of the embodiments described herein can be variously made.

Further, descriptions of technical details that are well known in the art and/or not directly related to the disclosure may he omitted in order to more clearly convey the subject matter of the disclosure without obscuring the disclosure with unnecessary descriptions.

In the drawings, some elements are exaggerated, omitted, or only outlined in brief, and the size of each element does not necessarily reflect the actual size. The same or similar reference symbols are used throughout the drawings to refer to the same or like parts.

Advantages and features of the disclosure and methods for achieving them will be apparent from the following detailed description of embodiments taken in conjunction with the accompanying drawings. However, the disclosure is not limited to the embodiments disclosed below but may be implemented in various different ways, the embodiments are provided only to complete the disclosure and to fully inform the scope of the disclosure to those skilled in the art to which the disclosure pertains, and the disclosure is defined only by the scope of the claims.

Blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide steps for executing functions described in blocks of the flowchart.

Also, each block of a flowchart may correspond to a module, a segment, or a code containing one or more executable instructions for executing one or more logical functions, or to a part thereof. In some cases, functions described by blocks may be executed in an order different from the listed order in some alternative cases. For example, two blocks listed in sequence may be executed substantially at the same time or executed in reverse order according to the corresponding functionality.

Here, words such as “unit”, “module”, etc., used in the embodiments may refer to a software component or a hardware component such as a field-programmable gate array (FPGA) or an application-specific integrated circuit (ASIC) capable of carrying out a function or an operation. However, a “unit” or the like is not limited to hardware or software. For example, a unit may be configured to reside in an addressable storage medium or to drive one or more processors. For example, units may refer to components such as a software component, object-oriented software component, class component or task component, processes, functions, attributes, procedures, subroutines, program code segments, drivers, firmware, microcode, circuits, data, databases, data structures, tables, arrays, or variables. A function provided by a component and unit may be a combination of smaller components and units, and it may be combined with others to compose larger components and units. Components and units may be implemented to drive one or more processors in a device or a secure multimedia card.

The terms described below are defined in consideration of their functions in the disclosure, and these may vary depending on the intention of the user, the operator, or the custom. Hence, their meanings should be determined based on the overall contents of this specification.

In accordance with an embodiment of the disclosure, a method and apparatus are provided for supporting various services in a wireless communication system. Specifically, the disclosure describes a method for improving the performance of communication services and efficiently utilizing network resources by managing requests for communication session information received from a UE running an application and an application server in a wireless communication system and providing state information.

The terms used in the following description for identifying an access node, indicating a network entity or a network function (NF), indicating a message, indicating an interface between network entities, and indicating various identification information are taken as illustration for ease of description. Accordingly, the disclosure is not limited by the terms to be described later, and other terms referring to objects having an equivalent technical meaning may be used.

For convenience of description, the disclosure uses terms and names defined in 3rd generation partnership project (3GPP) long term evolution (LTE) and 5G standards. However, the disclosure is not limited by the above terms and names, and may be equally applied to systems conforming to other standards.

For ease of description, the name of an NF (e.g., access and mobility management function (AMF), SMF, or network slice selection function (NSSF)) is used as an agent for exchanging information for access control and state management. However, the embodiments of the disclosure can be equally applied even when the NF is actually implemented as an instance (e.g., AMF instance, SMF instance, or NSSF instance).

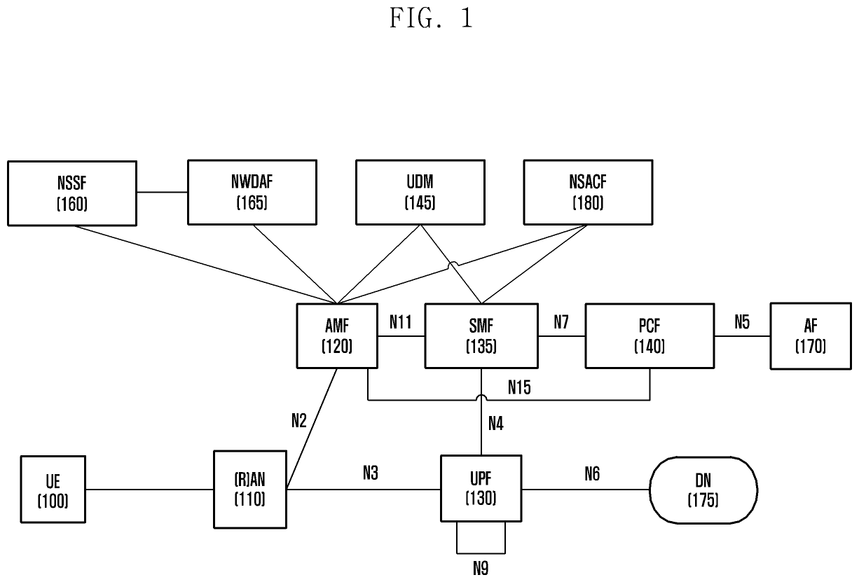

FIG. 1 illustrates a 5GS according to an embodiment.

Referring to FIG. 1, a 5GS may include a 5G core network, a base station (e.g., an access network (AN) or a radio access network (RAN)) 110, and a UE 100. The 5G core network includes an AMF 120, an SMF 135 a user plane function (UPF) 130, a policy control function (PCF) 140, a user data management (UDM) 145, NSSF 160, NWDAF 165, and a non-3GPP function (N3F).

The UE 100 may access the 5G core network through the AN base station 110. The base station 110 may support 3GPP access network type (e.g., NR, E-UTRA, etc.) or non-3GPP access network type (e.g., Wi-Fi). The UE 100 may be connected over an N2 interface to the AMF 120 through the base station 110, and may be connected over the N3 interface to the UPF 130. The base station 110 may be referred to as another term having a technical meaning that is equivalent to that of a base station, such as access point (AP), eNodeB (eNB), 5^{th} generation node (5G node), gNodeB (gNB), etc. An N3F is an NF that serves as terminations of the N2 interface and N3 interface towards the UE 100 accessing via a non-3GPP access network that is not defined in 3GPP (e.g., Wi-Fi). The N3F may process N2 control plane signaling and N3 user plane packets.

The AMF 120 is an NF for managing wireless network access and mobility of the UE. The SMF 135 is an NF that manages a session for the UE, and the session information includes quality-of-service (QoS) information, charging information, and packet processing information. The UPF 130 is an NF that processes user traffic (e.g., user plane traffic), and is controlled by the SMF 135. The PCF 140 is an NF that manages operator policies for providing services in the wireless communication system. The UDM 145 is an NF that stores and manages subscription information (e.g., a UE subscription) of the UE.

A unified data repository (UDR) is an NF that stores and manages data. The UDR may store UE subscription information and provide UE subscription information to the UDM. In addition, the UDR may store operator policy information and provide operator policy information to the PCF.

The NWDAF 165 is an NF that provides analysis information for the 5GS to operate. The NWDAF may collect data from other NFs or operations, administration and maintenance (OAM) constituting the 5GS, analyze the collected data, and provide the analysis results to other NFs.

An network slice admission control function (NSACF) 180 is an NF that monitors and controls the number of registered UEs and the number of sessions of a network slice that is a target of NSAC. The NSACF stores configuration information on the maximum number of registered UEs and the maximum number of sessions for each network slice.

An application function (AF) is an NF for transferring signaling messages between an external or internal application server and the 5G network. The AF finds a suitable NF in the 5G network and forwards a request message from a server to it on behalf of the application server, and stores the mapping relationship. When the 5G network transmits information to an application server, the AF allows the information to be forwarded to the corresponding application server.

For convenience of description below, entities that exchange information for access control and state management will be collectively described as an NF. However, embodiments of the disclosure may be equally applied even when an NF is actually implemented with an instance (e.g., an AMF instance, an SMF instance, or an NSSF instance).

Herein, an instance may indicate a state where a specific NF exists in the form of software code and can be executed on a physical computing system, e.g., a specific computing system existing on the core network to perform the function of the NF by using physical or/and logical resources allocated from the computing system. Hence, an NF instance such as an AMF instance, SMF instance, and NSSF instance may use physical and/or logical resources allocated from a specific computing system existing on the core network for AMF operation, SMF operation, and NSSF operation. As a result, an NF instance such as an AMF instance, SMF instance, or NSSF instance, which uses physical or/and logical resources allocated from a specific computing system existing on the network for AMF, SW or NSSF operation, may perform the same operation as when a physical NF entity such as an AMF, an SMF or an NSSF exists. Therefore, items described using NFs (e.g., an AMF, an SMF, a UPF, an NSSF, a network repository function (NRF), or a service communication proxy (SCP) may be replaced with items described using NF instances, or, conversely, items described using NF instances may be replaced items described using NFs. Similarly, items described using a network slice may be replaced with items described using a network slice instance, or, conversely, items described using a network slice instance may be replaced with items described using a network slice.

In a 5GS defined by 3GPP, one network slice may be indicated by single-network slice selection assistance information (S-NSSAI). The S-NSSAI may include a slice/service type (SST) value and a slice differentiator (SD) value. The SST may indicate the characteristic of a service supported by the slice (e.g., eMBB, Internet of things (IoT), URLLC, or V2X). The SD may be used as an additional identifier (ID) for a specific service indicated by the SST.

The NSSAI may include one or more S-NSSAIs. Examples of NSSAI may include, but is not limited to, configured NSSAI stored in the UE, requested NSSAI requested by the UE, allowed NSSAI allowed to be used by the UE and determined by an NE (e.g., an AMF, are NSSF, etc.) of the 5G core network, and subscribed NSSAI to which the UE is subscribed.

The UE 100 may be simultaneously connected to the base station 110 and registered in the 5GS. Specifically, the UE 100 may connect to the base station 110 to perform a UE registration procedure with the AMF 120.

During the registration procedure, the AMF 120 may determine an allowed slice (e.g., allowed NSSAI) available to the UE connected to the base station 110 and allocate it to the UE 100. The UE 100 may select a specific slice to establish a protocol data unit (PDU) session for communication with an actual application server. One PDU session may include one or plural QoS flows, and plural QoS flows can provide different transmission performances required for individual application services by setting different QoS parameters. In addition, one PDU session may include session mode information. The session mode information may include information regarding whether the anchor point of the corresponding PDU session should be fixed or relocated when the location of the UE is changed, whether multiple anchor points can be used in the process of relocation, or the ratio of computing load distributed between the UE and the server for applications to which split computing is applied.

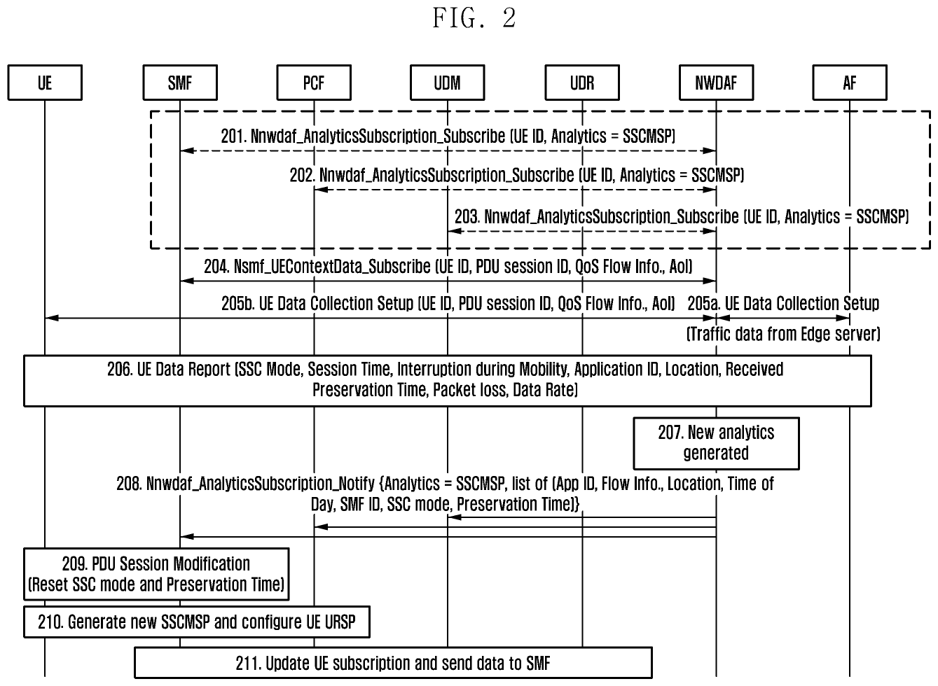

FIG. 2 illustrates a procedure for updating a session mode selection policy of a UE according to an embodiment. More specifically, FIG. 2 illustrates a session establishment procedure for determining a session mode selection policy and applying it when creating a new session or changing the session mode for the already created session of the UE.

Referring to FIG. 2, in steps 201 to 203, the SMF, the PCF, and the UDM, as consumers of the NWDAF service, subscribe to the data analytics service of the NWDAF in order to receive analytics data for session mode policy determination. The subscription request message for the data analytics service transmitted by each consumer function may include at least one of an ID of the UE to be analyzed or a parameter for indicating session mode selection policy (e.g., a session and service continuity mode selection policy (SSCMSP)) data as a data type to be analyzed.

In step 204, the NWDAF subscribes to the data provision service of the SMF in order to collect network data for providing analytics data for the session mode selection policy.

In step 205a, to collect UE data for providing analytics data for the session mode selection policy, the NWDAF subscribes to an AF service and performs a setup process for collecting UE data. When the AF is an edge server, it is also possible to provide statistical data on application traffic used by the UE to the NWDAF.

In step 205b, the AF or the NWDAF may perform a setup process for collecting UE data with the UE according to an NWDAF request. Here, to indicate the session information as the data to be collected by the UE for reporting, in the setup process, the AF or NWDAF may deliver at least one of a UE ID, a PDU session ID, a QoS flow ID, or area-of-interest (AOI) information indicating a collection area to the UE.

Also, in the setup process, the AF or NWDAF may transmit, to the UE, information indicating the data to be collected by the UE. For example, the AF or NWDAF may transmit at least one of a service and session continuity (SSC) mode, a session time, an interruption during mobility, an application ID, location, received preservation time, packet loss, and data rate to the UE.

In step 206, the UE collects the requested data when using each application in the indicated area and time according to the information requested by the AF or NWDAF and transmits the results to the AF. The AF forwards the data received from the UE to the NWDAF.

In step 207, the NWDAF analyzes the UE data collected and transmitted from the UE to produce new analytics results.

In step 208, the NWDAF transmits the analytics results produced in step 207 to the individual consumer functions that have requested data analytics for the session mode selection policy in steps 201 to 203.

In step 209, upon receiving the analytics result from the NWDAF, the SMF requests to change the session mode of the session being used by the UE. The SMF may change the session mode of the current session by performing a session modification procedure.

In step 210, as an alternative of step 209, upon receiving the analytics result from the NWDAF, the PCF generates a new session mode selection policy to be applied to the UE, and performs a UE configuration update procedure with the UE to deliver the new session mode selection policy to the UE by including the new session mode selection policy in UE route selection policy (URSP) information. The UE may perform a session modification procedure for changing the mode of the currently ongoing session by applying the new session mode selection policy included in the URSP information received through the UE configuration update procedure, or may use the new session mode selection policy to set the session mode specified in the session mode selection policy in the process of setting up a new session for a specified application in the future.

In step 211, based on the analytics result received from the NWDAF, the UDM determines a session mode selection policy of the UE, updates subscription information of the UE, and transmits the updated subscription information of the UE to the SMF. The SMF may identify the newly set session mode selection policy information from the updated subscription information of the UE, and may perform a session modification procedure for changing the mode of the currently ongoing session by applying it, or utilize it to set the session mode specified in the session mode selection policy in the process of setting up a new session for a specified application in the future.

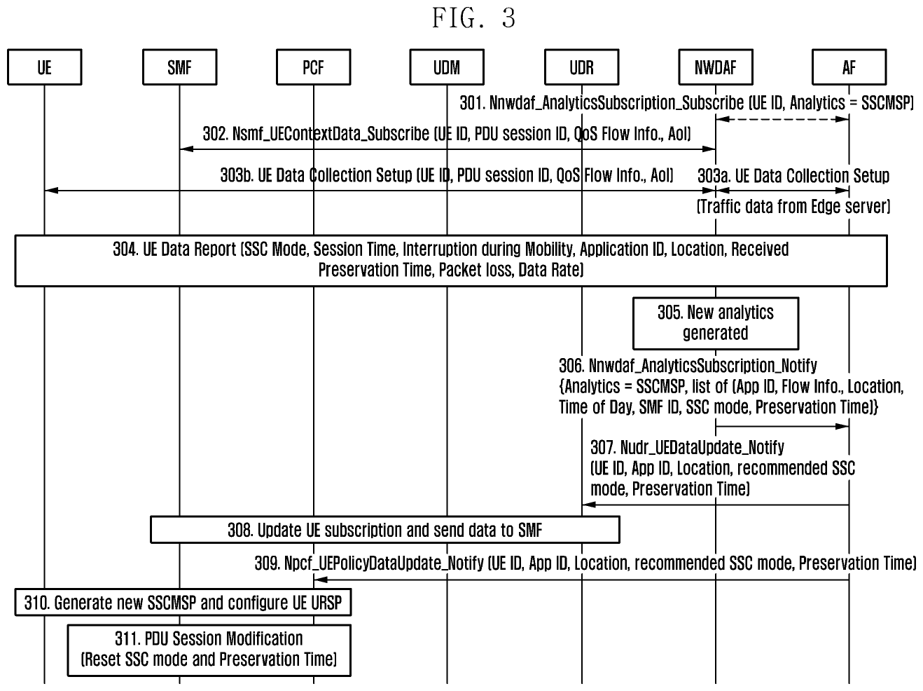

FIG. 3 illustrates a procedure for updating a session mode selection policy of a UE according to an embodiment. More specifically, FIG. 3 illustrates a session establishment procedure for determining a session mode selection policy and applying it when creating a new session or changing the session mode for the already created session of the UE according to an embodiment.

Referring to FIG. 3, in step 301, the AF subscribes to the data analytics service of the NWDAF in order to receive analytics data for session mode policy determination. The subscription request message for the data analytics service may include at least one of an ID of the UE to be analyzed or a parameter for indicating session mode selection policy (e.g., an SSCMSP) data as a data type to be analyzed.

In step 302, the NWDAF subscribes to the data provision service of the SMF to collect network data for providing analytics data for the session mode selection policy.

In step 303a, to collect UE data for providing analytics data for the session mode selection policy, the NWDAF may subscribe to an AF service and perform a setup process for collecting UE data. When the AF is an edge server, it is also possible to provide statistical data on application traffic used by the UE to the NWDAF.

In step 303b, the AF or the NWDAF performs a setup process for collecting UE data with the UE according to a NWDAF request. Here, to indicate the session information as the data to be collected by the UE for reporting, in the setup process, the AF or NWDAF may deliver at least one of a UE ID, a PDU session ID, a QoS flow ID, or AOI information indicating a collection area to the UE.

Also, in the setup process, the AF or NWDAF may transmit information indicating the data to be collected by the UE to the UE. For example, the AF or NWDAF may deliver at least one of: SSC mode, session time, interruption during mobility, application ID, location, received preservation time, packet loss, and data rate to the UE.

In step 304, the UE collects the requested data when using each application in the indicated area and time according to the information requested by the AF or NWDAF and transmits the results to the AF. The AF may forward the data received from the UE to the NWDAF.

In step 305, the NWDAF analyzes the UE data collected and transmitted from the UE in order to produce new analytics results.

In step 306, the NWDAF transmits the analytics results produced in step 305 to the AF having requested data analytics for the session mode selection policy in step 301.

In step 307, the AF uses the analytics result received from the NWDAF to determine the session mode required by the UE to use the application, and requests, from the 5G network, information to be applied to the session mode selection policy of the UE. The session mode selection policy information transmitted by the AF may be stored in the UDR through the NRF in the form of UE subscription information.

In step 308, the UDM confirms that the subscription information of the UE has been changed and transmits the changed subscription information to the SMF. Upon receiving the changed subscription information from the UDM, the SMF may perform a session modification procedure for changing the session mode of step 311 below.

In step 309, as an alternative of steps 307 and 308, the AF uses the analytics result received from the NWDAF to determine the session mode required by the UE to use the application, and performs a process of requesting this information to be applied to the session mode selection policy of the UE by transmitting it to the PCF.

In step 310, the PCF generates a new session mode selection policy to be applied to the UE from the session mode selection policy information transmitted by the AF, and performs a UE configuration update procedure with the UE to deliver the new session mode selection policy to the UE by including it in the URSP information. The UE may perform a session modification procedure for changing the mode of the currently ongoing session by applying the new session mode selection policy included in the URSP information received through the UE configuration update procedure, or may use the new session mode selection policy to set the session mode specified in the session mode selection policy in the process of setting up a new session for a specified application in the future.

In step 311, the PCF determines a new session mode selection policy to be applied to the UE from the session mode selection policy information transmitted by the AF, and transmits the updated session mode selection policy to the SMF. The SMF may perform a session modification procedure to change the mode of the currently ongoing session by applying the new session mode selection policy, or utilize it to set the session mode specified in the session mode selection policy in the process of accepting a request for new session setup from the UE intending to use a specified application in the future.

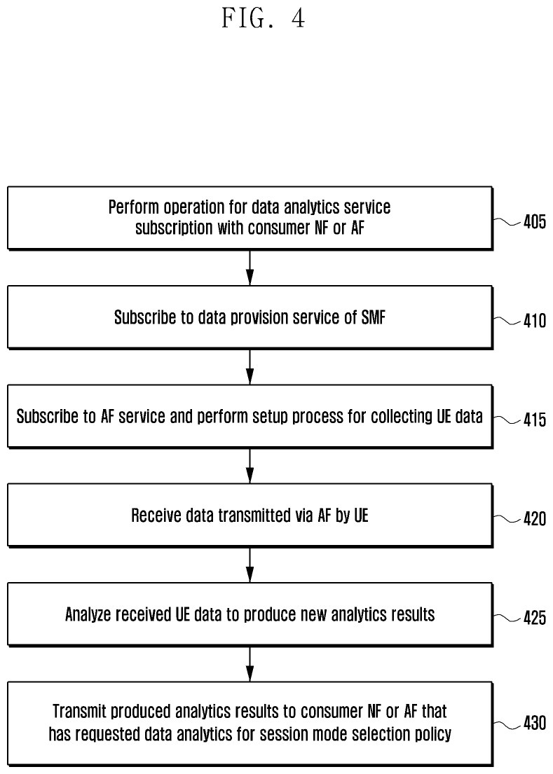

FIG. 4 is a flowchart illustrating operations of an NWDAF according to an embodiment.

Referring to FIG. 4, in step 405, the NWDAF performs a data analytics service subscription operation with a consumer NF (e.g., an SMF, a PCF, or a UDM) or the AF. For example, the NWDAF may receive a subscription request message for the data analytics service from the consumer NF or AF. The subscription request message for the data analytics service may include at least one of an ID of a UE to be analyzed or a parameter for indicating SSCMSP data as a data type to be analyzed. In response to the subscription request message for the data analysis service, the NWDAF may transmit a response message (e.g., subscription acceptance or subscription rejection) to the consumer NF or AF.

In step 410, the NWDAF subscribes to the data provision service of the SMF in order to collect network data for providing analytics data for the session mode selection policy. For example, the NWDAF may transmit a subscription request message for the network data provision service to the SMF. The subscription request message for the network data provision service may include at least one of UE ID, a PDU session ID, a QoS flow ID, or AOI information indicating a collection area. The NWDAF may receive a response message (e.g., subscription acceptance or subscription rejection), from the SMF, in reply to the subscription request message for the network data provision service. The NWDAF may receive network data for providing analytics data for the session mode selection policy from the SMF.

In step 415, to collect UE data for providing analytics data for the session mode selection policy; the NWDAF subscribes to an AF service and performs a setup process for collecting UE data. When the AF is an edge server, the NWDAF may receive statistical data on application traffic used by the UE. To indicate the session information as the data to be collected by the UE for reporting, in the setup process, the AF or NWDAF may deliver at least one of a UE ID, a PDU session ID, a QoS flow ID, or AOI information indicating a collection area to the UE.

Also, in the setup process, the NWDAF may transmit information indicating the data to be collected by the UE to the UE. For example, the NWDAF may deliver at least one of an SSC mode, a session time, an interruption during mobility, an application ID, a location, a received preservation time, a packet loss, and a data rate to the UE.

In step 420, the NWDAF receives data transmitted, via the AF, by the UE. The data transmitted by the UE to the AF may be collected when the UE uses each application in an indicated area and time according to information requested by the AF or NWDAF.

In step 425, the NWDAF analyzes the UE data collected and transmitted from the UE in order to produce new analytics results.

In step 430, the NWDAF transmits the produced analytics results to the consumer NF or AF that has requested data analytics for the session mode selection policy. The analytics results may be used by the SMF to change the session mode of the current session by performing a session modification procedure.

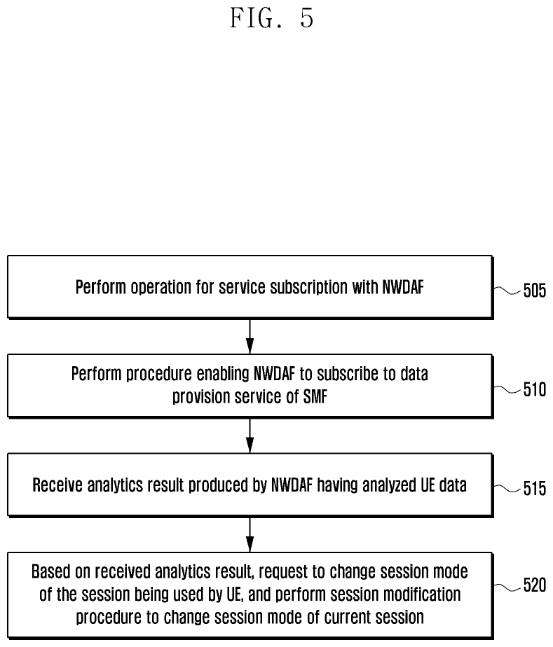

FIG. 5 is a flowchart illustrating operations of an SMF according to an embodiment.

Referring to FIG. 5, in step 505, the SMF performs a data analytics service subscription operation with the NWDAF. For example, the SMF may transmit a subscription request message for the data analytics service to the NWDAF. The subscription request message for the data analytics service may include at least one of an ID of a UE to be analyzed or a parameter for indicating SSCMSP data as a data type to be analyzed. In response to the subscription request message for the data analysis service, the SMF may receive a response message (e.g., subscription acceptance or subscription rejection) from the NWDAF.

In step 510, the SMF performs a procedure that allows the NWDAF to subscribe to the data provision service of the SMF in order to collect network data for providing analytics data for the session mode selection policy. For example, the SMF may receive a subscription request message for the network data provision service from the NWDAF. The subscription request message for the network data provision service may include at least one of a UE ID, a PDU session ID, a QoS flow ID, or AOI information indicating a collection area. The SMF may transmit a response message (e.g., subscription acceptance or subscription rejection) to the NWDAF in reply to the subscription request message for the network data provision service. The SW may transmit network data for providing analytics data for the session mode selection policy to the NWDAF.

In step 515, the SMF receives an analytics result produced by the NWDAF having analyzed the UE data.

In step 520, the SMF requests to change the session mode of the session being used by the UE based on the received analytics result. The SMF may change the session mode of the current session by performing a session modification procedure.

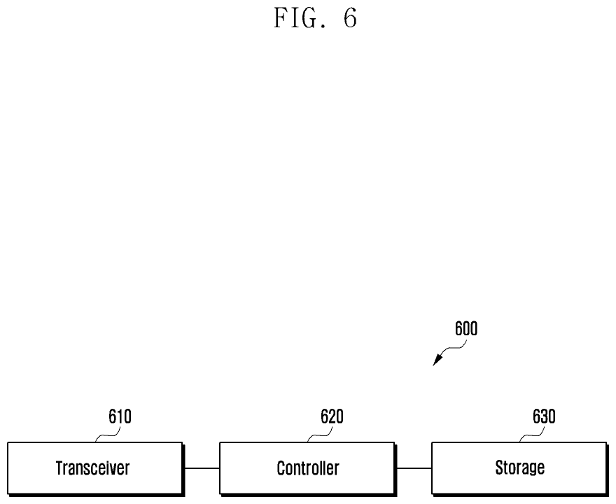

FIG. 6 illustrates an NF of a 5GS according to an embodiment. For example, the NF 600 may be an SW, a PCF, a UDM, an NWDAF, or an AF.

Referring to FIG. 6, the NF 600 includes a transceiver 610, a controller 620, and a storage 630. The controller 620 may be defined as a circuit, an ASIC, or at least one processor.

The transceiver 610 may transmit and receive signals to and from other network entities. The transceiver 610 may transmit and receive a signal to and from, e,g., a UE, a base station, or another NF.

The controller 620 may control the overall operation of the NF 600 according to the above-described embodiments of the disclosure. For example, the controller 620 may control signal flows between blocks to perform operations according to the above-described flowcharts.

The storage 630 may store at least one of information transmitted and received through the transceiver 610 or information generated through the controller 620.

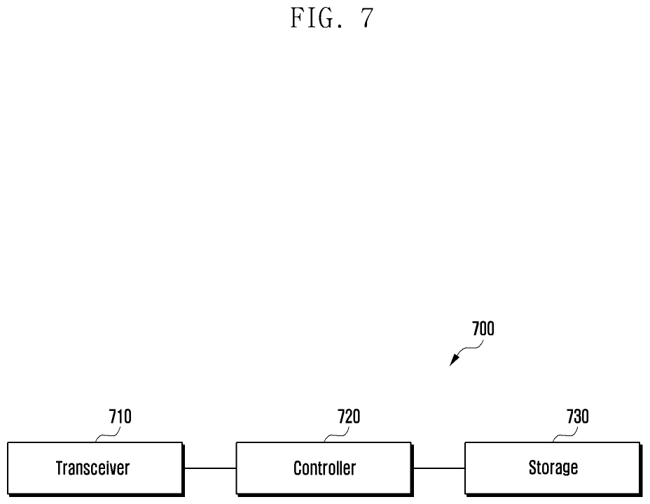

FIG. 7 illustrates a UE according to an embodiment.

Referring to FIG. 7, the UE 700 includes a transceiver 710, a controller 720, and a storage 730. The controller 720 may be defined as a circuit, an ASIC, or at least one processor.

The transceiver 710 may transmit and receive signals to and from other network entities. The transceiver 710 may transmit and receive a signal to and from, e.g., a base station or an NF of the 5GS.

The controller 720 may control the overall operation of the UE 700 according to the above-described embodiments of the disclosure. For example, the controller 720 may control signal flows between blocks to perform operations according to the above-described flowcharts.

The storage 730 may store at least one of information transmitted and received through the transceiver 710 or information generated through the controller 720.

Among the above-described embodiments and methods, individual configurations or steps may he selectively combined and applied. In addition, all of the steps described above are not necessarily included according to settings and/or definitions on the system, and some steps may be omitted.

The embodiments of the disclosure disclosed in the present specification and drawings are presented as specific examples to easily explain the technical contents of the disclosure and help the understanding of the disclosure, and are not intended to limit the scope of the disclosure. It will be apparent to those of ordinary skill in the art to which the disclosure pertains that other modifications based on the technical spirit of the disclosure can be carried out in addition to the embodiments disclosed herein. In addition, the above embodiments may be applied in combination with each other as needed.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method performed by a network data analytics function (NWDAF) in a mobile communication system, the method comprising:
receiving, from a session management function (SMF), a message requesting a subscription to a data analysis service related to a service and session continuity mode selection policy (SSCMSP);
obtaining network data provided by a network data provision service of the SMF and user equipment (UE) data collected by a for the data analysis service;
generating analytics for the SSCMSP based on the network data and the UE data; and
transmitting, to the SMF, the analytics for the SSCMSP.

2. The method of claim 1, wherein the analytics for the SSCMSP are used to reset a service and session continuity (SSC) mode used by the UE.

3. The method of claim 1, further comprising transmitting a message for a UE data collection setup,
wherein the message for the UE data collection setup includes at least one of a UE identifier (ID), a protocol data unit (PDU) session ID, a quality of service (QoS) ID, or an area of interest for collecting the UE data.

4. The method of claim 1, wherein the UE data includes at least one of a service and session continuity (SSC) mode used by the UE, a session time, an interruption during mobility, an application identifier (ID), a location of the UE, a received preservation time, a packet loss, or a data rate.

5. A method performed by a session management function (SMF) in a mobile communication system, the method comprising:
transmitting, to a network data analytics function (NWDAF), a message requesting a subscription to a data analysis service related to a service and session continuity mode selection policy (SSCMSP);
transmitting, to the NWDAF, network data provided by a network data provision service of the SMF; and
receiving, from the NWDAF, analytics for the SSCMSP,
wherein the analytics for the SSCMSP are based on the network data and user equipment (UE) data collected by a UE for the data analysis service.

6. The method of claim 5, wherein the analytics for the SSCMSP are used to reset a service and session continuity (SSC) mode used by the UE.

7. The method of claim 5, wherein the UE data includes at least one of a service and session continuity (SSC) mode used by the UE, a session time, an interruption during mobility, an application identifier (ID), a location of the UE, a received preservation time, a packet loss, or a data rate.

8. A method performed by a user equipment (UE) in a mobile communication system, the method comprising:
receiving a message for a UE data collection setup triggered by a network data analytics function (NWDAF);
collecting UE data for a data analysis service related to a service and session continuity mode selection policy (SSCMSP) based on the message for the UE data collection setup; and
transmitting the collected UE data for the data analysis service.

9. The method of claim 8, wherein the message for the UE data collection setup includes at least one of a UE identifier (ID), a protocol data unit (PDU) session ID, a quality of service (QoS) ID, or an area of interest for collecting the UE data.

10. The method of claim 8, wherein the UE data includes at least one of a service and session continuity (SSC) mode used by the UE, a session time, an interruption during mobility, an application identifier (ID), a location of the UE, a received preservation time, a packet loss, or a data rate.

11. A network data analytics function (NWDAF) in a mobile communication system, the NWDAF comprising:
a transceiver; and
a controller configured to:
receive, from a session management function (SMF), via the transceiver, a message requesting a subscription to a data analysis service related to a service and session continuity mode selection policy (SSCMSP),
obtain network data provided by a network data provision service of the SMF and user equipment (UE) data collected by a UE for the data analysis service,
generate analytics for the SSCMSP based on the network data and the UE data, and
transmit, to the SMF, via the transceiver, the analytics for the SSCMSP.

12. The NWDAF of claim 11, wherein the analytics for the SSCMSP are used to reset a service and session continuity (SSC) mode used by the UE.

13. The NWDAF of claim 11, wherein the controller is further configured to transmit, via the transceiver, a message for a UE data collection setup, and
wherein the message for the UE data collection setup includes at least one of a UE identifier (ID), a protocol data unit (PDU) session ID, a quality of service (QoS) ID, or an area of interest for collecting the UE data.

14. The NWDAF of claim 11, wherein the UE data includes at least one of a service and session continuity (SSC) mode used by the UE, a session time, an interruption during mobility, an application identifier (ID), a location of the UE, a received preservation time, a packet loss, or a data rate.

15. A session management function (SMF) in a mobile communication system, the SMF comprising:
a transceiver; and
a controller configured to:
transmit, to a network data analytics function (NWDAF), via the transceiver, a message requesting a subscription to a data analysis service related to a service and session continuity mode selection policy (SSCMSP),
transmit, to the NWDAF, via the transceiver, network data provided by a network data provision service of the SMF, and
receive, from the NWDAF, via the transceiver, analytics for the SSCMSP,
wherein the analytics for the SSCMSP are based on the network data and user equipment (UE) data collected by a UE for the data analysis service.

16. The SMF of claim 15, wherein the analytics for the SSCMSP are used to reset a service and session continuity (SSC) mode used by the UE.

17. The SMF of claim 15, wherein the UE data includes at least one of a service and session continuity (SSC) mode used by the UE, a session time, an interruption during mobility, an application identifier (ID), a location of the UE, a received preservation time, a packet loss, or a data rate.

18. A user equipment (UE) in a mobile communication system, the UE comprising:
a transceiver; and
a controller configured to:
receive, via the transceiver, a message for a UE data collection setup triggered by a network data analytics function (NWDAF),
collect UE data for a data analysis service related to a service and session continuity mode selection policy (SSCMSP) based on the message for the UE data collection setup, and
transmit, via the transceiver, the collected UE data for the data analysis service.

19. The UE of claim 18, wherein the message for the UE data collection setup includes at least one of a UE identifier (ID), a protocol data unit (PDU) session ID, a quality of service (QoS) ID, or an area of interest for collecting the UE data.

20. The UE of claim 18, wherein the UE data includes at least one of a service and session continuity (SSC) mode used by the UE, a session time, an interruption during mobility, an application identifier (ID), a location of the UE, a received preservation time, a packet loss, or a data rate.
